(19) United States
(12) Patent Application Publication
(10) Pub. No.: US 2005/0091951 A1
(43) Pub. Date: May 5, 2005

(54) AIR FILTER HOLDING TRAY

(76) Inventor: Oscar Adolfo MORENO, Ciudad De BS. AS. (AR)

Correspondence Address: GODFREY & KAHN S.C., 780 NORTH WATER STREET, MILWAUKEE, WI, 53202, US

(21) Appl. No.: 10/708,794

(22) Filed: Mar. 25, 2004

(30) Foreign Application Priority Data
Nov. 3, 2003 (AR) M 03 01 04018

(51) Int. Cl. B01D 46/00

(52) U.S. Cl. 55/502

(57) ABSTRACT

The present invention refers to air filter holding trays, especially as used in air conditioner systems. The air filter holding tray frames include at least one sealing element. Preferably, the sealing element is held by longitudinal tray tracks with fibers or bristles on one side of the sealing element.

### CROSS REFERENCE TO RELATED APPLICATIONS

Present application seeks priority from Republic of Argentina application No. M 03 01 04018 filed on Nov. 3, 2003. This application is incorporated in its entirety for all purposes.

### BACKGROUND OF INVENTION

The present invention generally relates to air filters and specifically to air filter holding trays.

Air filter holding trays, specially air filter holding trays used in air conditioners, have been known for many decades. In practice, however, as the air filters begin to get dirty, the air stops going out through the air filter and instead goes out through the space that exists between the air filter and the air filter holding tray. Air that exits this way does not get filtered, and thus reduces the quality of the air provided to a precinct by the air conditioning system.

The quality of the air is important in any precinct, but is especially important in some precincts, such as operating rooms or others where the air can be the means for transmission of diseases.

Accordingly, the need exists for an improved filtering apparatus that can improve the quality of air without the necessity of constantly replacing new air filters and without the aid of any specialized tools. Of course, the present invention may be used in a multitude of systems where similar air cleaning and replacing capabilities are desired. Thus, the present invention should not be interpreted as being limited to application in connection with air filters used in air conditioning units

### SUMMARY OF INVENTION

The present invention is designed to solve the problems associated with the prior art by including a perimeter seal in the holding tray to prevent air from passing through the space between the air filter and the holding tray.

A preferred embodiment of the present invention provides a holding tray which comprises a frame having tracks to support a sealing element. The sealing element may further be connected to fibers or bristles, in an alternate embodiment, the fibers or bristles may be made as an integral part of the sealing element.

In another preferred embodiment, the bristles or fibers may be made from organic or inorganic fibers. Such bristles or fibers may be in particular made from any polymeric materials, and preferably, polypropylene.

The sealing element in yet another preferred embodiment may have at least two sides, first side that substantially connects to the tray tracks of the frame and a second side connected to the fibers or bristles.

In sum, the present invention represents a significant improvement over the prior art in many ways, including allowing quick inspection and change of inner assembly, economical design, and ease of use. These and other objects and advantages of the present invention will become apparent from the detailed description accompanying the drawings.

### BRIEF DESCRIPTION OF DRAWINGS

FIG. 1 is a perspective view of a fragmentary portion of a preferred embodiment of the air filter frame.

FIG. 2 is a perspective view of a partially cut air filter frame as shown in FIG. 1.

FIG. 3 is a perspective view of the entire air filter frame as shown in FIG. 1.

### DETAILED DESCRIPTION

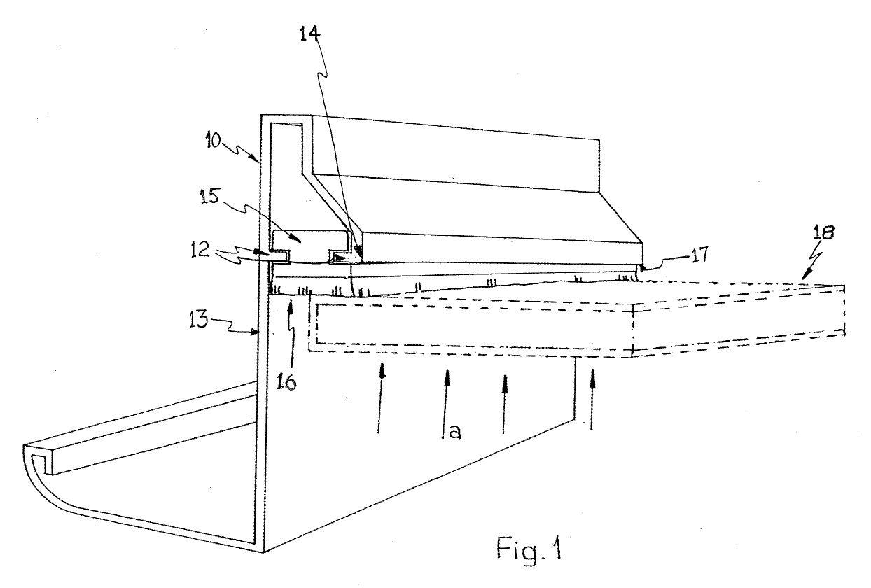

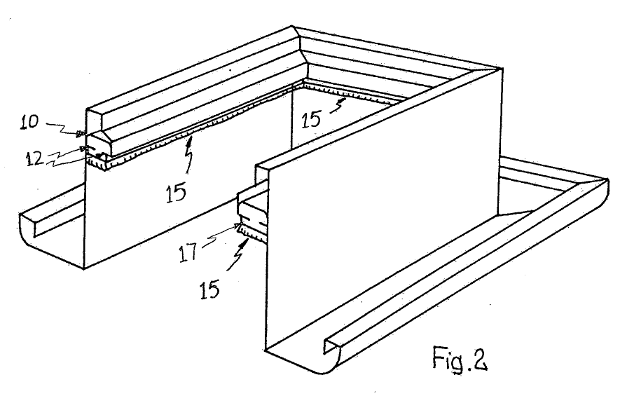

Now referring to FIG. 1, one embodiment of the present invention provides a frame 10. Frame 10 further includes air filter holding tray rack 12 along its side 13, and first periphery 14. A sealing element 15 is positioned substantially along the tray track 12. One lateral side of the sealing element 15 is connected to the tray track 12 by any means known to one of ordinary skill in the art. In a preferred embodiment, the sealing element 15 is connected to the tray tracks, substantially as shown in FIGS. 1 and 2. Further a second lateral side of the sealing element is connected to bristles or fibers 16. In another preferred embodiment, the sealing element may be manufactured such that bristles or fibers 16 are a part of the sealing element 15.

The sealing element 15 is made by any material capable of holding the weight of the sealing element 15 along with the bristles and fibers 16. The sealing element 15 is preferably made from a easily moldable material like rubber or a material that includes plastic blisters to best prevent unfiltered air passage. The fibers or bristles may be made from any organic or inorganic materials, organic or inorganic sponges, or any other material known to one of ordinary skill in the art for filtering air. More specifically polypropylene fibers or bristles may be used in a preferred embodiment. In another preferred embodiment, the plastic bristles 16 are positioned along the exposed outer surface 17 of the second lateral side of the sealing element 15. In yet another preferred embodiment, the plastic bristles 14 run the entire length of the second lateral side of the sealing element 15. Any desirable filter 18 known to one of ordinary skill in the art may be positioned substantially beneath the bristles or fibers 16.

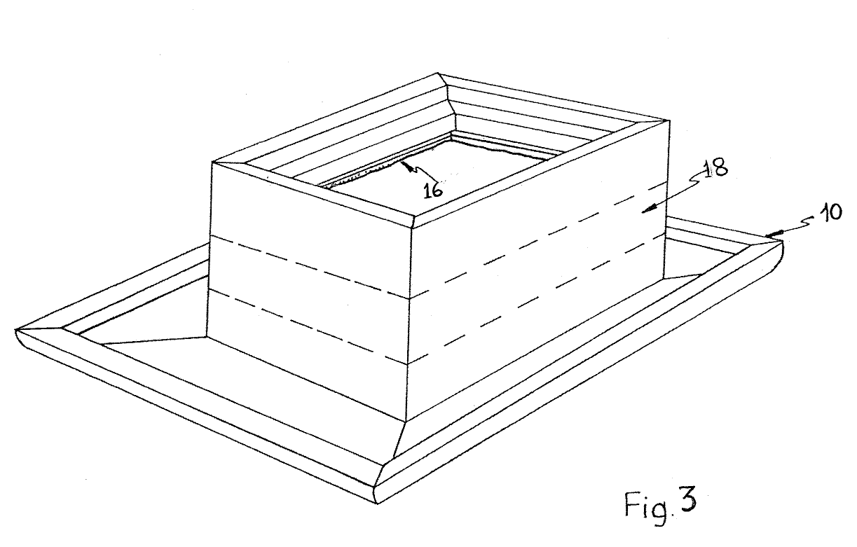

FIG. 2 depicts a partially cut frame, showing in detail how the sealing element 15 along with bristles or fibers 16 runs along the exposed outer surface 17 of the tray track 12. FIG. 3 depicts the entire air filter frame 10, the sealing element 15, plastic bristles 16 and the filter 18.

In operation, as shown in FIG. 1, the air gets in from the bottom, following the direction of the arrows “a”, goes though the filter 18, being unable to escape through the lateral borders because of the sealing element 15, located along its entire perimeter of the tray track 12. Due to that sealing element 15, air that does not pass through the filter will also not substantially pass through the borders of the filter 18, thereby resulting in better air quality.

The filtering apparatus of the present invention may have other applications aside from use in air conditioning system. Additionally, the direction of fluid flow has been described herein in the preferred orientation but it should be apparent to one of skill in the art that the flow direction could be reversed. Thus, although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims.

1) An air filter holding tray for use in the air conduit systems, comprising:
a frame
at least one sealing element; and
holding system for holding said sealing element to the frame.

2) An air filter holding tray according to claim 1 wherein said holding system for holding said sealing element are tray tracks.

3) An air filter holding tray according to claim 1, wherein the sealing element is further connected to fibers or bristles.

4) An air filter holding tray according to claim 1, wherein the sealing element includes fibers or bristles.

5) An air filter holding tray according to claim 1, wherein the fibers or bristles are made from organic or inorganic fibers.

6) An air filter holding tray according to claim 5, wherein the fibers or bristles are made from polymers.

7) An air filter holding tray according to claim 6, wherein the polymer is polypropylene.

8) An air filter holding tray according to claim 1, wherein said the sealing element has at least two sides, first side that is substantially connected to the tray tracks of the frame and a second side that connected to the fibers or bristles.
